(19) United States
(12) Patent Application Publication
(10) Pub. No.: US 2012/0315476 A1
(43) Pub. Date: Dec. 13, 2012

(54) ADHESIVE COMPOSITION AND SURFACE PROTECTION FILM USING THE SAME

(76) Inventors: Hiroshi OGAWA, Yokohamashi (JP); Tatsuhiro Suwa, Yokohamashi (JP); Cheong Hun Song, Uiwang-si (KR)

(21) Appl. No.: 13/155,872

(22) Filed: Jun. 8, 2011

(51) Int. Cl. B32B 27/30; C08G 69/08; C08G 63/06

(52) U.S. Cl. 428/355 R; 525/450; 525/421

(57) ABSTRACT

An adhesive composition includes 100 parts by weight of a (meth)acrylate copolymer including 0 to less than 0.5 parts by weight of a carboxyl group containing monomer, 0.6 to 9 parts by weight of a hydroxyl group containing (meth)acrylic monomer, and 90.5 to 99.4 parts by weight of a (meth)acrylic acid ester monomer, and having a weight average molecular weight of 100,000 g/mol to less than 1,000,000 g/mol; and 0.1 to 5 parts by weight of a carbodiimide cross-linking agent.

### BACKGROUND

1. Field

Embodiments relate to an adhesive composition and a surface protection film using the same.

2. Description of the Related Art

Generally, various optical films, such as a polarizer plate, a phase difference plate, and an antireflection film, are deposited on a flat display panel, such as a liquid crystal display (LCD) and a plasma display panel (PDP). A release film or a surface protection film is attached to an optical film, using an adhesive layer, to prevent scratches or contamination in manufacture and distribution. For example, a surface protection film is attached to a polarizer plate through an adhesive layer in order to protect the polarizer plate attached to a flat display panel while mounting the flat display panel on a television receiver or a mobile phone case or mounting wires on the flat display panel.

### SUMMARY

An embodiment is directed to an adhesive composition, including 100 parts by weight of a (meth)acrylate copolymer including 0 to less than 0.5 parts by weight of a carboxyl group containing monomer, 0.6 to 9 parts by weight of a hydroxyl group containing (meth)acrylic monomer, and 90.5 to 99.4 parts by weight of a (meth)acrylic acid ester monomer, and having a weight average molecular weight of 100,000 g/mol to less than 1,000,000 g/mol; and 0.1 to 5 parts by weight of a carbodiimide cross-linking agent.

The (meth)acrylate copolymer may have a weight average molecular weight of 200,000 g/mol to 900,000 g/mol.

The adhesive composition may further include 0.05 to 3 parts by weight of an isocyanate cross-linking agent.

The (meth)acrylate copolymer may further include at least one of an epoxy group containing acrylic monomer, an amino group containing acrylic monomer, a phosphate group containing acrylic monomer, a sulfonic acid group containing acrylic monomer, a urethane group containing acrylic monomer, a phenyl group containing acrylic vinyl monomer, a silane group containing vinyl monomer, styrene, chlorostyrene, α-methylstyrene, vinyltoluene, vinyl chloride, vinyl acetate, vinyl propionate, acrylonitrile, and vinyl pyridine.

The adhesive composition may further include a silane coupling agent.

The adhesive composition may have a viscosity of 500 to 6,000 mPa·s at 25° C.

Another embodiment is directed to a surface protection film including a protection film and an adhesive layer formed on at least one side of the protection film, the adhesive layer including the adhesive composition according to an embodiment.

The adhesive layer may have an adhesion of 0.02 to 0.2 N/25 mm based on JIS Z0237.

### BRIEF DESCRIPTION OF THE DRAWINGS

The above and other features and advantages will become more apparent to those of skill in the art by describing in detail example embodiments with reference to the attached drawings, in which:

FIG. 1 illustrates Table 2, listing components used to form the polymer (A) of Synthesis Examples 1-19; and

FIG. 2 illustrates Table 4, listing components used in the adhesive compositions of Examples 1 to 10 and Comparative Examples 1 to 9 as well as performance test results.

### DETAILED DESCRIPTION

Japanese Patent Application No. 2009-280740, filed on Dec. 10, 2009, in the Japan Patent Office, and entitled: “Adhesive Composition and Surface Protection Film using the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

An embodiment relates to an adhesive composition including: 100 parts by weight of a (meth)acrylate copolymer including 0 to less than 0.5 parts by weight of a carboxyl group containing monomer, 0.6 to 9 parts by weight of a hydroxyl group containing (meth)acrylic monomer, and 90.5 to 99.4 parts by weight of a (meth)acrylic acid ester monomer, and having a weight average molecular weight of 100,000 g/mol to less than 1,000,000 g/mol; and 0.1 to 5 parts by weight of a carbodiimide cross-linking agent.

In the present embodiment, the carboxyl group containing monomer forming the (meth)acrylate copolymer is present in an amount of less than 0.5% by weight (wt %) based on the total amount of the monomers of the copolymer. Due to control of the amount of the carboxyl group containing monomer, adhesion is not excessively high but is properly adjusted so that the adhesive composition is easily released, and the adhesive composition hardly or never remains on an adherend when released. Further, within this amount, excessive increase in adhesion after long-time storage is controlled and prevented, so that the adhesive composition is easily released from an adherend, such as a polarizer plate. In this case, the adhesive composition also hardly or never remains on the adherend when released.

In the present embodiment, the carbodiimide cross-linking agent is used as a cross-linking agent for the (meth)acrylate copolymer. Accordingly, an adhesive layer has a cross-linking structure to deal with contraction by pressure and temperature in autoclaving. Thus, the adhesive layer formed of the adhesive composition prevents bubbles at high temperature and high pressure (in autoclaving) and has excellent adherend contamination resistance and transparency. Further, since a surface protection film in which the adhesive layer formed of the adhesive composition is disposed hardly forms bubbles at high temperature and high pressure, it hardly or never affects the quality inspection of a flat display panel, such as an LCD or PDP, when used as a surface protection film, e.g., for a polarizer plate. In addition, the adhesive layer formed of the adhesive composition also has appropriate adhesion and adhesiveness to a substrate and excellent metal corrosion resistance and low-temperature stability.

Herein, the expression “adherend contamination resistance is excellent” or “excellent adherend contamination resistance” means that a change in contact angle is 3 degrees or less before and after a surface protection film having an adhesive layer formed of the adhesive composition is released from an adherend, and adherend contamination resistance is evaluated by the method described in the following examples. Further, the expression “transparency is excellent” or “excellent transparency” means that white turbidity is not identified with the naked eye in an adhesive layer formed of the adhesive composition, and transparency is evaluated by the method described in the following examples. Also, metal corrosion control and prevention properties, adhesion, adhesiveness to a substrate, adherend contamination resistance (adherend anti-contamination properties), low-temperature stability, transparency, and presence of bubbles at high temperature and high pressure (in autoclaving), which is referred to as “autoclaving suitability,” are evaluated by the methods described in the following examples.

The adhesive composition according to an embodiment is effective in bonding an adherend, such as various plastic films, and is particularly proper for an adhesive layer of a surface protection film, e.g., for a polarizer plate, in a flat display panel, such as an LCD or PDP.

Herein, a “(meth)” compound will collectively refer to both a compound and a meth-containing compound. For example, “(meth)acryl” includes both acryl and methacryl, “(meth)acrylate” includes both acrylate and methacrylate, and “(meth)acrylic acid” includes both acrylic acid and methacrylic acid.

(A) (Meth)Acrylate Copolymer

In the present example embodiment, the (meth)acrylate copolymer forming the adhesive composition includes 0 to less than 0.5 parts by weight of a carboxyl group containing monomer (denoted by “a-1”), 0.6 to 9 parts by weight of a hydroxyl group containing (meth)acrylic monomer (denoted by “a-2”), and 90.5 to 99.4 parts by weight of a (meth)acrylic acid ester monomer (denoted by “a-3”).

The (meth)acrylate copolymer may have a weight average molecular weight (Mw) of 100,000 g/mol to less than 1,000,000 g/mol, preferably 200,000 g/mol to 900,000 g/mol. When the weight average molecular weight is 100,000 g/mol or more, it may be easier to form an adhesive layer and/or form an adhesive layer having significantly better adhesion or adhesiveness to a substrate (adherend). When the weight average molecular weight is less than 1,000,000 g/mol, the manufacturing process may be simplified, resulting in cost efficiency, and the adhesive layer may avoid unduly high adhesion or adhesiveness to a substrate (adherend), so that part of the adhesive layer does not remain on the substrate when released from the substrate. With the weight average molecular weight in this range, the (meth)acrylate copolymer may be easily and inexpensively manufactured in a short time. Further, the solution of the (meth)acrylate copolymer having such weight average molecular weight may have a low viscosity. Thus, it may easily and conveniently be applied to a substrate, such as a protection film, and the thickness of the adhesive layer may be easily controlled.

(a-1) Carboxyl Group Containing Monomer

In the present example embodiment, the carboxyl group containing monomer is an unsaturated monomer having at least one carboxyl group. Examples of the carboxyl group containing monomer may include (meth)acrylic acid, maleic acid, maleic anhydride, fumaric acid, fumaric anhydride, crotonic acid, itaconic acid, itaconic anhydride, myristic acid, palmitic acid, and oleic acid. Among these, (meth)acrylic acid, maleic acid, maleic anhydride, fumaric acid, fumaric anhydride, crotonic acid, itaconic acid, and itaconic anhydride are preferable; and (meth)acrylic acid is more preferable. These carboxyl group containing monomers may be used alone or as mixtures.

In the present example embodiment, the carboxyl group containing monomer may be present in an amount of 0 to less than 0.5 parts by weight based on 100 parts by weight of the total amount of the monomers. When the amount is 0.5 parts by weight or more, the adhesive layer has too high adhesion, so that it is difficult to release the adhesive layer from a substrate (adherend), such as a polarizer plate, or the adhesive layer can remain on the substrate after being released.

(a-2) Hydroxyl Group Containing (Meth)Acrylic Monomer

In the present example embodiment, the hydroxyl group containing (meth)acrylic monomer is an acrylic monomer having a hydroxyl group. Examples of the hydroxyl group containing (meth)acrylic monomer may include 2-hydroxyethyl (meth)acrylate, 4-hydroxybutyl (meth)acrylate, 1,6-hexanediol mono(meth)acrylate, pentaerythritol tri(meth)acrylate, dipentaerythritol penta(meth)acrylate, neopentylglycol mono(meth)acrylate, trimethylolpropane di(meth)acrylate, trimethylolethane di(meth)acrylate, 2-hydroxypropyl (meth)acrylate, 2-hydroxybutyl (meth)acrylate, 2-hydroxy-3-phenyloxypropyl (meth)acrylate, 4-hydroxycyclohexyl (meth)acrylate, 2-hydroxyethyl acrylamide, and cyclohexane dimethanol monoacrylate. Further, the hydroxyl group containing (meth)acrylic monomer may include compounds obtained by addition reaction of a glycidyl group containing compound, such as alkyl glycidyl ether, allyl glycidyl ether, and glycidyl (meth)acrylate, with (meth)acrylic acid. Among these compounds, 2-hydroxyethyl (meth)acrylate, 4-hydroxybutyl (meth)acrylate, 2-hydroxyethyl acrylamide, and cyclohexane dimethanol monoacrylate are preferable; 2-hydroxyethyl (meth)acrylate, 4-hydroxybutyl (meth)acrylate, and 2-hydroxyethyl acrylamide are more preferable; and 2-hydroxyethyl acrylate, 4-hydroxybutyl acrylate, and 2-hydroxyethyl acrylamide are even more preferable. These hydroxyl group containing (meth)acrylic monomers may be used alone or as mixtures.

In the present example embodiment, the hydroxyl group containing (meth)acrylic monomer may be present in an amount of 0.6 to 9 parts by weight based on 100 parts by weight of the total amount of the monomers. When the amount is 0.6 parts by weight or more, a crosslink points formed by reaction of the hydroxyl group of the hydroxyl group containing (meth)acrylic monomer with the carbodiimide cross-linking agent may avoid being too small, which could prevent sufficient adhesion. When the amount is 9 parts by weight or less, crosslink points may be formed by reaction of the hydroxyl group of the hydroxyl group containing (meth)acrylic monomer with the carbodiimide cross-linking agent, while avoiding too many are crosslink points, such that adhesion does not increase too much and the adhesive layer retains sufficient transparency.

(a-3) (Meth)Acrylic Acid Ester Monomer

In the present example embodiment, the (meth)acrylic acid ester monomer is an ester of (meth)acrylic acid having no hydroxyl group. Examples of the (meth)acrylic acid ester monomer may include, without being limited to, methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, isoamyl (meth)acrylate, n-hexyl (meth)acrylate, n-heptyl (meth)acrylate, n-octyl (meth)acrylate, tert-octyl (meth)acrylate, 2-ethylhexyl (meth)acrylate, decyl (meth)acrylate, isodecyl (meth)acrylate, tridecyl (meth)acrylate, stearyl (meth)acrylate, isostearyl (meth)acrylate, phenyl (meth)acrylate, benzyl (meth)acrylate, dodecyl (meth)acrylate, tetrahydrofurfuryl (meth)acrylate, cyclohexyl (meth)acrylate, 4-n-butylcyclohexyl (meth)acrylate, 2-ethylhexyl diglycol (meth)acrylate, butoxyethyl (meth)acrylate, butoxymethyl (meth)acrylate, 3-methoxybutyl (meth)acrylate, 2-(2-methoxyethoxy)ethyl (meth)acrylate, 2-(2-butoxyethoxy)ethyl (meth)acrylate, 4-butylphenyl (meth)acrylate, phenyl (meth)acrylate, 2,4,5-tetramethyl phenyl (meth)acrylate, phenoxymethyl (meth)acrylate, polyethylene oxide monoalkyl ether (meth)acrylate, polypropylene oxide monoalkyl ether (meth)acrylate, trifluoroethyl (meth)acrylate, pentadecafluorooxyethyl (meth)acrylate, 2-chloroethyl (meth)acrylate, 2,3-dibromopropyl (meth)acrylate, and tribromophenyl (meth)acrylate. Among these monomers, methyl acrylate, ethyl acrylate, n-butyl acrylate, isobutyl acrylate, tert-butyl acrylate, and 2-ethylhexyl (meth)acrylate are preferable; methyl acrylate, ethyl acrylate, n-butyl acrylate, and 2-ethylhexyl acrylate are more preferable; and methyl acrylate, n-butyl acrylate, and 2-ethylhexyl acrylate are even more preferable. These (meth)acrylic acid ester monomers may be used alone or as mixtures.

In the present example embodiment, the (meth)acrylic acid ester monomer may be present in an amount of 90.5 to 99.4 parts by weight based on 100 parts by weight of the total amount of the monomers.

(a-4) Other Monomers

In the present example embodiment, the (meth)acrylate copolymer may be prepared by copolymerization of the carboxyl group containing monomer (a-1), the hydroxyl group containing (meth)acrylic monomer (a-2), and the (meth)acrylic acid ester monomer (a-3). For example, the (meth)acrylate copolymer may be prepared by copolymerization of the monomers (a-1), (a-2), and (a-3) only. That is, the (meth)acrylate copolymer may include a component unit derived from the carboxyl group containing monomer (a-1), a component unit derived from the hydroxyl group containing (meth)acrylic monomer (a-2), and a component unit derived from the (meth)acrylic acid ester monomer (a-3) only. In this case, the total amount of the carboxyl group containing monomer (a-1), the hydroxyl group containing (meth)acrylic monomer (a-2), and the (meth)acrylic acid ester monomer (a-3) is 100 parts by weight.

In another implementation, the (meth)acrylate copolymer may further include a component unit derived from other monomers, i.e., monomers other than the monomers (a-1) to (a-3). The other monomers may include any suitable monomer copolymerizable with the monomers (a-1) to (a-3). The other monomers may be, e.g.: an epoxy group containing acrylic monomer, such as glycidyl (meth)acrylate and methyl glycidyl (meth)acrylate; an amino group containing acrylic monomer, such as dimethylaminoethyl (meth)acrylate, diethylaminoethyl (meth)acrylate, N-tert-butylaminoethyl (meth)acrylate, and methacryloxyethyl trimethylammonium chloride (meth)acrylate; an amide group containing acrylic monomer, such as (meth)acrylamide, N-methylol (meth)acrylamide, N-methoxymethyl (meth)acrylamide, and N,N-methylene bis(meth)acrylamide; a phosphate group containing acrylic monomer, such as 2-methacryloyloxyethyl diphenyl phosphate (meth)acrylate, trimethacryloyloxyethyl phosphate (meth)acrylate, and triacryloyloxyethyl phosphate (meth)acrylate; a sulfonic acid group containing acrylic monomer, such as sodium sulfopropyl (meth)acrylate, sodium-2-sulfoethyl (meth)acrylate, and sodium-2-acrylamid-2-methylpropane sulfonate; a urethane group containing acrylic monomer, such as urethane (meth)acrylate; a phenyl group containing acrylic vinyl monomer, such as p-tert-butylphenyl (meth)acrylate and o-biphenyl (meth)acrylate; a silane group containing vinyl monomer, such as vinyltrimethoxysilane, vinyltriethoxysilane, vinyl tris(β-methoxyethyl)silane, vinyl triacetylsilane, and methacryloyloxypropyltrimethoxysilane; styrene; chlorostyrene; α-methylstyrene; vinyltoluene; vinyl chloride; vinyl acetate; vinyl propionate; acrylonitrile; vinyl pyridine; etc. Among these monomers, (meth)acrylamide, glycidyl (meth)acrylate, dimethylaminoethyl (meth)acrylate, acrylamide, and dimethylaminoethyl (meth)acrylate, are more preferable. These monomers may be used alone or as mixtures. The other monomers may be present in an amount not inhibiting characteristics of the monomers (a-1) to (a-3). The amount may be 0.1 to 10 parts by weight, preferably 0.2 to 5 parts by weight, and more preferably 0.3 to 2 parts by weight based on 100 parts by weight of the monomers (a-1) to (a-3).

The (meth)acrylate copolymer may be prepared by any suitable method, e.g., solution polymerization, emulsion polymerization, suspension polymerization, reverse-phase suspension polymerization, thin-film polymerization, and spray polymerization, which use a polymerization initiator. Polymerization control may be conducted by thermal insulation polymerization, temperature control polymerization, and isothermal polymerization. In addition to a method of using a polymerization initiator to initiate polymerization, irradiation, electromagnetic radiation, and UV radiation may be used to initiate polymerization. Among these methods, solution polymerization using a polymerization initiator may be used so that molecular weight is easily adjusted and impurities may be decreased. For example, the (meth)acrylate copolymer may be produced by adding 0.01 to 0.5 parts by weight of a polymerization initiator to 100 parts by weight of the total amount of the monomers using ethyl acetate, toluene, or methyl ethyl ketone as a solvent, followed by reaction under a nitrogen atmosphere at 60 to 90° C. for 3 to 10 hours. Examples of the polymerization initiator may include: azo compounds, such as azobisisobutyronitrile (AIBN), 2-2′-azobis(2-methylbutyronitrile), and azobiscyanovaleric acid; organic peroxides, such as tert-butyl peroxypivalate, tert-butyl peroxybenzoate, tert-butyl peroxy-2-ethylhexanoate, di-tert-butyl peroxide, cumene hydroperoxide, benzoyl peroxide, and tert-butyl hydroperoxide; and inorganic peroxides, such as hydrogen peroxide, ammonium persulfate, potassium persulfate, and sodium persulfate. These initiators may be used alone or as mixtures.

The (meth)acrylate copolymer prepared by copolymerization of the monomers (a-1) to (a-3), or prepared by copolymerization of the monomers (a-1) to (a-3) and the other monomers (a-4), may have a weight average molecular weight Mw of 100,000 g/mol to less than 1,000,000 g/mol, preferably 200,000 g/mol to 900,000 g/mol. When the weight average molecular weight is less 100,000 g/mol or more, it may be easier to form an adhesive layer and/or form an adhesive layer having significantly better adhesion or adhesiveness to a substrate (adherend). When the weight average molecular weight is less than 1,000,000 g/mol, the manufacturing process may be simplified, resulting in cost-efficient, and the adhesive layer may avoid unduly high adhesion or adhesiveness to a substrate (adherend), so that part of the adhesive layer does not remain on the substrate when released from the substrate. With the weight average molecular weight in this range, the (meth)acrylate copolymer can be easily, rapidly, and inexpensively manufactured. Further, the solution of the (meth)acrylate copolymer having such weight average molecular weight may have a low viscosity. Thus, application thereof to a substrate such as a protection film may be easy and convenient, and the thickness of the adhesive layer may be easily controlled. Herein, the weight average molecular weight is based on a polystyrene standard measured by the method stated in the following examples.

The adhesive composition may include the above (meth)acrylate copolymers alone or as mixtures.

(B) Carbodiimide Cross-Linking Agent

In the present example embodiment, the adhesive composition may include a carbodiimide cross-linking agent in addition to the (meth)acrylate copolymer. The carbodiimide cross-linking agent reacts with and is coupled to a hydroxyl group or a carboxyl group, particularly a hydroxyl group, of a monomer forming the (meth)acrylate copolymer, thereby forming a cross-linking structure.

The carbodiimide cross-linking agent may include any suitable carbodiimide cross-linking agent. For example, a compound having at least two carbodiimide groups (—N═C═N—) in the molecular structure may be used, and any suitable polycarbodiimide may be used.

Further, the carbodiimide compound may include high-molecular-weight polycarbodiimide prepared by decarbonation condensation reaction of diisocyanate in the presence of a carbodiimide catalyst.

Examples of the compound may include compounds obtained by decarbonation condensation reaction of the following diisocyanates.

The diisocyanates include 4,4′-diphenylmethane diisocyanate, 3,3′-dimethoxy-4,4′-diphenylmethane diisocyanate, 3,3′-dimethyl-4,4′-diphenylmethane diisocyanate, 4,4′-diphenylether diisocyanate, 3,3′-dimethyl-4,4′-diphenylether diisocyanate, 2,4-tolylene diisocyanate, 2,6-tolylene diisocyanate, 1-methoxyphenyl-2,4-diisocyanate, isophorone diisocyanate, 4,4′-dicyclohexylmethane diisocyanate, and tetramethyl xylene diisocyanate, and may be used alone or as mixtures.

The carbodiimide catalyst may include phospholene oxides, such as 1-phenyl-2-phospholene-1-oxide, 3-methyl-2-phospholene-1-oxide, 1-ethyl-3-methyl-2-phospholene-1-oxide, 1-ethyl-2-phospholene-1-oxide, 3-phospholene, and isomers thereof.

In addition, commercially available carbodiimide cross-linking agents may be used. For example, the high-molecular-weight polycarbodiimide may include CARBODILITE® (Nisshinbo Chemical Inc.), specifically CARBODILITE V-01, V-03, V-05, V-07 and V09, which have excellent compatibility with organic solvents.

In the present example embodiment, the carbodiimide cross-linking agent may be present in an amount of 0.1 to 5 parts by weight based on 100 parts by weight of the (meth)acrylate copolymer. When the amount of the carbodiimide cross-linking agent (B) is less 0.1 parts by weight or more, the adhesive layer may exhibit a desirable level of cross-linking structure, thereby realizing sufficient adhesion. When the amount is too small, adherend contamination resistance or transparency may be decreased and bubbles may be generated at high temperature and high pressure (in autoclaving). Maintaining the amount at 5 parts by weight or less may help preserve the transparency of the adhesive layer.

The adhesive composition may include the above carbodiimide cross-linking agents alone or as mixtures.

(C) Isocyanate Cross-Linking Agent

In the present example embodiment, the adhesive composition includes the (meth)acrylate copolymer and the carbodiimide cross-linking agent. In another implementation, the adhesive composition may further include an isocyanate cross-linking agent. The isocyanate cross-linking agent reacts with and is coupled to a hydroxyl group or a carboxyl group, particularly a hydroxyl group, of a monomer forming the (meth)acrylate copolymer, thereby forming a cross-linking structure. Due to further addition of the isocyanate cross-linking agent, the adhesive layer formed of the adhesive composition may have improved durability.

The isocyanate cross-linking agent may include any suitable isocyanate cross-linking agent, for example, aromatic diisocyanates, such as triallyl isocyanate, dimeric acid diisocyanate, 2,4-tolylene diisocyanate (2,4-TDI), 2,6-tolylene diisocyanate (2,6-TDI), 4,4′-diphenylmethane diisocyanate (4,4′-MDI), 2,4′-diphenylmethane diisocyanate (2,4′-MDI), 1,4-phenylene diisocyanate, xylylene diisocyanate (XDI), tetramethylxylylene diisocyanate (TMXDI), toluidine diisocyanate (TODI), and 1,5-naphthalene diisocyanate (NDI); aliphatic diisocyanates, such as hexamethylene diisocyanate (HDI), trimethylhexamethylene diisocyanate (TMHDI), lysine diisocyanate, and norbornane diisocyanate (NBDI); alicyclic isocyanates, such as trans-cyclohexane-1,4-diisocyanate, isophorone diisocyanate (IPDI), H6-XDI (hydrogen added XDI), and H12-MDI (hydrogen added MDI); carbodiimide-modified diisocyanates of the foregoing diisocyanates; or isocyanurate-modified diisocyanates thereof. In addition, adducts of the foregoing isocyanate compounds and polyol compounds, such as trimethylolpropane, or biurets and isocyanurates of the isocyanate compounds may be used.

The isocyanate cross-linking agent may be synthesized or a commercially available product may be used. Commercially available isocyanate cross-linking agents may include Colonate L, Colonate HL, Colonate HX, Colonate 2030, Colonate 2031 (registered trade names, Nippon Polyurethane Industry Co., Ltd.), Takenate D-102, Takenate D-110N, Takenate D-200, Takenate D-202 (registered trade names, Mitsui Chemicals Inc.), Duranate 24A-100, Duranate TPA-100, Duranate TKA-100, Duranate P301-75E, Duranate E402-90T, Duranate E405-80T, Duranate TSE-100, Duranate D-101, and Duranate D-201 (trade names, Asahi Kasei Corporation). Among these, Colonate L, Colonate HL, Colonate HX, Takenate D-110N, and Duranate 24A-100 are preferable; Colonate L, Colonate HX, and Takenate D-110N are more preferable; and Colonate L and Colonate HX are even more preferable.

The amount of the isocyanate cross-linking agent may be properly adjusted based on the composition of the (meth)acrylate copolymer, the kind, and the amount of the carbodiimide cross-linking agent, or the like. When the isocyanate cross-linking agent is added, the isocyanate cross-linking agent may be present in an amount of 0.05 to 3 parts by weight, preferably 0.1 to 2 parts by weight based on 100 parts by weight of the (meth)acrylate copolymer. Within this range, the adhesive layer formed of the adhesive composition may exhibit enhanced durability.

The adhesive composition may include the above isocyanate cross-linking agents alone or as mixtures.

The carbodiimide cross-linking agent, or the carbodiimide cross-linking agent and the isocyanate cross-linking agent, react with and are coupled to a hydroxyl group or carboxyl group, particularly a hydroxyl group, of a monomer forming the (meth)acrylate copolymer, thereby forming a cross-linking structure. Here, a cross-linking ratio is not specifically limited. The adhesive composition may have a gel content of 80 to 100%, preferably 90 to 100% in view of adhesion, adhesiveness to a substrate, adherend contamination resistance, low-temperature stability, transparency, presence of bubbles at high temperature and high pressure (autoclaving suitability), and strength when the adhesive layer is formed. Herein, “gel content” is a parameter indicating the cross-linking ratio of the (meth)acrylate copolymer and is measured by the method described in the following examples.

(D) Other Additives

Instead of, or in addition to, the isocyanate cross-linking agent (C), the adhesive composition may further include additives, such as a curing accelerator, an ionic liquid, a lithium salt, a silane coupling agent, an inorganic filler, a softener, an antioxidant, an anti-aging agent, a stabilizer, a tackifier resin, a reforming resin (polyol resin, phenolic resin, acrylic resin, polyester resin, polyolefin resin, epoxy resin, epoxylated polybutadiene resin, etc.), a leveling agent, an antifoaming agent, a plasticizer, a dye, a pigment (coloring and extender pigments), a treatment agent, a UV blocking agent, a fluorescent whitening agent, a dispersant, a heat stabilizer, a light stabilizer, a UV absorber, an anti-static agent, a lubricant, and a solvent. Among these, examples of the curing accelerator may include dibutyltin dilaurate, JCS-50 (Johoku Chemical Company Ltd.), and Formate TK-1 (Mitsui Chemicals Inc.).

Examples of the ionic liquid may include materials having cations, such as phosphonium, pyridinium, pyrrolidinium, imidazolium, guanidinium, ammonium, isouronium, thiouronium, piperidium, pyrazolium, and sulfonium ions, and anions, such as halide, nitrate, sulfate, phosphate, perchlorate, thiocyanate, thiosulfate, sulfite, tetrafluoroborate, hexafluorophosphate, formate, oxalate, acetate, trifluoroacetate, and alkyl sulfonate ions.

Examples of the antioxidant may include dibutylhydroxytoluene (BHT), Irganox 1010, Irganox 1035FF, and Irganox 565 (registered trade names, Chiba Specialty Chemicals Co., Ltd.).

Examples of the tackifier resin may include rosins, such as rosin acid, polymerized rosin acid, and rosin acid ester, a terpene resin, a terpene phenolic resin, an aromatic hydrocarbon resin, an aliphatic saturated hydrocarbon resin, and a petroleum resin.

Examples of the silane coupling agent may include methyltrimethoxysilane, dimethyldimethoxysilane, trimethylmethoxysilane, n-propyltrimethoxysilane, ethyltrimethoxysilane, diethyldiethoxysilane, n-butyltrimethoxysilane, n-hexyltriethoxysilane, n-octyltrimethoxysilane, phenyltrimethoxysilane, diphenyldimethoxysilane, cyclohexylmethyldimethoxysilane, vinyltrichlorosilane, vinyltrimethoxysilane, vinyltriethoxysilane, vinyl tris(β-methoxyethoxy)silane, β-(3,4-epoxycyclohexyl)ethyltrimethoxysilane, γ-glycidoxypropyltrimethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-β-(aminoethyl)-γ-aminopropylmethyldimethoxysilane, N-β-(aminoethyl)-γ-aminopropyltrimethoxysilane, N-β-(aminoethyl)-γ-aminopropyltriethoxysilane, γ-aminopropyltrimethoxysilane, γ-aminopropyltriethoxysilane, N-phenyl-γ-aminopropyltrimethoxysilane, γ-chloropropyltrimethoxysilane, γ-mercaptopropyltrimethoxysilane, γ-mercaptopropylmethyldimethoxysilane, bis[3-(triethoxysilyl)propyl]tetrasulfide, and γ-isocyanatopropyltriethoxysilane. Further, a compound having a hydrolytic silyl group which is obtained by reaction of a silane coupling agent having a functional group, e.g., an epoxy group (glycidoxy group), amino group, mercapto group, and (meth)acryloyl group, a silane coupling agent having a functional group reacting with the foregoing functional groups, other coupling agents, and polyisocyanate at a certain ratio with respect to each functional group may be used. The silane coupling agent may be synthesized or a commercially available product may be used. Commercially available silane coupling agents may include KBM-303, KBM-403, KBE-402, KBE-403, KBE-502, KBE-503, KBM-5103, KBM-573, KBM-802, KBM-803, KBE-846, and KBE-9007 (Shin-etsu Chemical Co., Ltd.).

When the additives are used, the amount of additives may be, for example 0.1 to 20 parts by weight based on 100 parts by weight of the total amount of the (meth)acrylate copolymer (A), the carbodiimide cross-linking agent (B), and, if necessary, the isocyanate cross-linking agent (C).

The adhesive composition may be prepared by mixing the above components at once or in order, or mixing a plurality of random components first and then adding the remaining components, and stirring the components into a uniform mixture. In detail, preparation may be conducted by heating to 30 to 40° C., if necessary, and stirring using a stirrer for 10 minutes to 5 hours until the mixture is uniform.

The adhesive composition may be used to bond various substrates, for example, a surface protection film, specifically for optical members. An embodiment provides a surface protection film which includes a protection film and an adhesive layer formed on least one side of the protection film, wherein the adhesive layer includes the adhesive composition according to an embodiment.

In the present example embodiment, the protection film is not specifically limited and may include any suitable protection film. For example, the protection film may be resin films, such as polyethylene terephthalate, polyethylene, polypropylene, an ethylene-vinyl acetate copolymer, polyester, polyvinyl chloride, polycarbonate, polyamide, and polystyrene films or composite films thereof. In an implementation, a polyethylene terephthalate film may be used. Further, the protection film may have a thickness of about 15 to 50 μm.

The adhesive layer may be formed on the protection film by applying the adhesive composition directly to the protection film, by transferring the adhesive composition deposited on a different substrate (e.g., release liner), or the like.

The adhesive composition may be applied by any suitable method used to manufacture an adhesive tape, e.g., various methods using a natural coater, a knife belt coater, a floating knife, roll coating, air knife coating, knife-over-roll coating, knife-on-blanket coating, spraying, dipping, kiss-roll coating, squeeze-roll coating, reverse-roll coating, an air blade, a curtain flow coater, a doctor blade, a wire bar, a die coater, a comma coater, a baker applicator and a gravure coater. Specifically, roll coating, gravure coating, reverse coating, roll brushing, spraying, air knife coating, and die coating may be used.

The adhesive composition may have a viscosity 500 to 6,000 mPa·s at 25° C., more preferably 1,000 to 4,000 mPa·s in view of application facilitation. Within this range, formation of an orange peel or stripe pattern on the applied surface may be avoided.

The thickness of the adhesive composition applied to the protection film (the thickness of the adhesive layer) may be properly adjusted depending on application. The thickness of the composition applied to the protection film (the thickness of the adhesive layer after drying) may be 3 to 200 μm, preferably 10 to 100 μm.

The surface protection film may be used to protect an optical member coupled to a flat display panel, such as an LCD or PDP. The optical member includes, for example, a polarizer plate, a phase difference plate, a brightness enhancement plate, a glare shield sheet, or the like. The polarizer plate, phase difference plate, antireflection film, etc., may be deposited on the flat display panel using an adhesive layer. The optical member may be a laminate of at least two optical elements, e.g., a laminate of a polarizer plate and a phase difference plate, a laminate of phase difference plates, a laminate of a polarizer plate and a brightness enhancement plate or a glare shield sheet, etc.

Further, the surface protection film may be used not only for independent optical member for distribution but also an optical member coupled to a flat display panel for distribution.

In the surface protection film according to an embodiment, the adhesive layer (adhesive composition) formed on the protection film may have an adhesion of 0.02 to 0.2 N/25 mm, preferably 0.05 to 0.15 N/25 mm. Within this range, the surface protection film can be comparatively easily released from an optical member, such as a polarizing film, for example, can be released at a rate of about 10 m/min. Herein, “adhesion” is measured according to a testing method of pressure-sensitive adhesive tapes and sheets in JIS Z0237, 2000, specifically by the method described in the following examples.

The adhesive layer may be formed of the adhesive composition according to an embodiment. As described above, the adhesive layer may provide appropriate adhesion and adhesiveness to a substrate and excellent metal corrosion resistance, adherend contamination resistance, low-temperature stability, and transparency, and may control and prevent bubbles at high temperature and high pressure (in autoclaving).

### EXAMPLES

The following Examples and Comparative Examples are provided in order to set forth particular details of one or more embodiments. However, it will be understood that the embodiments are not limited to the particular details described. Further, the Comparative Examples are set forth to highlight certain characteristics of certain embodiments, and are not to be construed as either limiting the scope of the invention as exemplified in the Examples or as necessarily being outside the scope of the invention in every respect.

The solid content and viscosity of a solution in which an adhesive composition is dissolved and the weight average molecular weight of an acrylic polymer (A) are measured by the following process.

<Solid Content>

About 1 g of a polymer solution was measured on a precisely weighed glass plate. The solution was dried at 105° C. for 1 hour and cooled to a room temperature and then the total mass of the glass plate and the remaining solid content was precisely measured. Defining the mass of the glass plate as X, the total mass of the glass plate and the polymer solution before drying as Y, and the total mass of the glass plate and the remaining solid content as Z, solid content was calculated by Equation 1.

Solid content(%)={(Z−X)/(Y−X)}×100 [Equation 1]

<Viscosity>

The temperature of the adhesive solution in a glass bottle was adjusted to 25° C. and then the viscosity was measured using a B-type viscometer.

<Weight Average Molecular Weight>

The weight average molecular weight was measured by the following method under the following conditions illustrated in Table 1.

TABLE 1

| | |
|---|---|
| Equipment | Gel Permeation Chromatography (GPC, Device No. GPC- |
| | 16) |
| Detector | Differential Refractive Index Detector (RI-8020, |
| | Sensitivity: 32, Tosoh Corporation) |
| | UV Absorbance Detector (2487, Wavelength: 215 nm, |
| | Sensitivity: 0.2 AUFS, Waters) |
| Column | Two TSKgel GMHXL, One G2500HXL |
| | (S/N M0052, M0051, N0010, φ7.8 mm × 30 cm, Tosoh |
| | Corporation) |
| Solvent | Tetrahydrofuran (Wako Junyaku Co., Ltd.) |
| Flow rate | 1.0 ml/min |
| Column | 23° C. |
| temperature | |
| Sample | Concentration: About 0.2% |
| | Dissolving: Smoothly stirred at room temperature |
| | Solubility: Dissolved (identified with the naked eye) |
| | Filtration: Filtrated using a 0.45 μm filter |
| Input | 0.200 ml |
| Reference | Monodispersed polystyrene |
| sample | |
| Data | GPC data processing system |
| processing | |

### Preparation Example 1

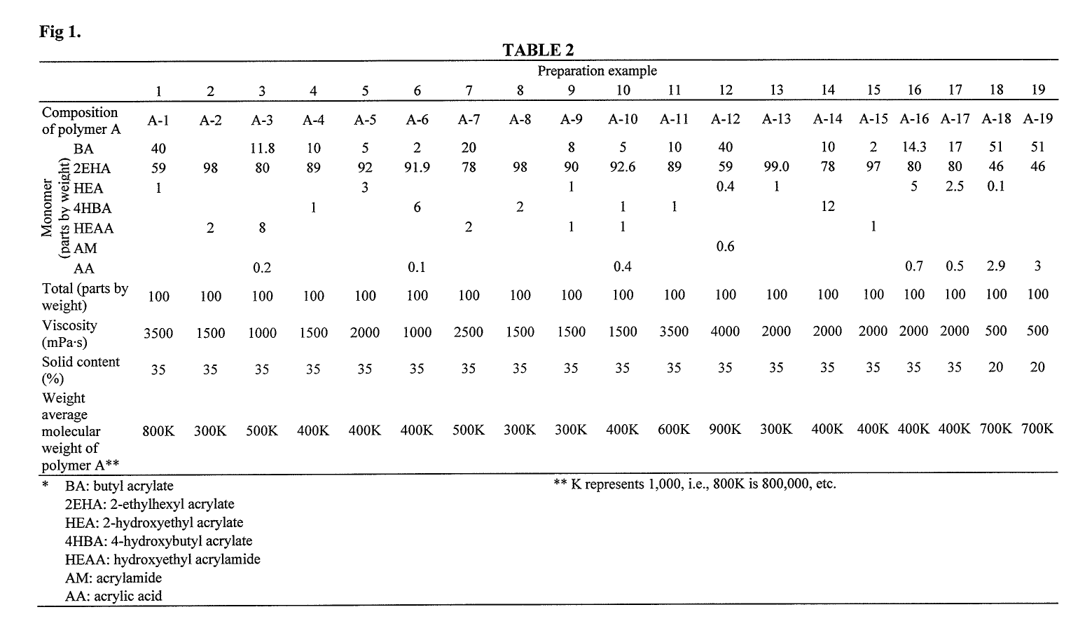

40 parts by weight of n-butyl acrylate (Nihon Shokubai, Co., Ltd.), 59 parts by weight of 2-ethylhexyl acrylate, 1 part by weight of 2-hydroxyethyl acrylate, and 150 parts by weight of ethyl acetate were put in a flask equipped with a reflux condenser and an agitator, and were heated to 65° C. under a nitrogen atmosphere. 0.1 parts by weight of azobisisobutyronitrile (AIBN) was added, and 0.05 parts by weight of AIBN was further added after 1 hour, followed by polymerization for 6 hours while maintaining the mixture at 65° C. After completing polymerization, 36 parts by weight of ethyl acetate was added, and the product was cooled to room temperature, thereby obtaining a solution of a copolymer (A-1). The solution of the copolymer (A-1) had a solid content of 35% and a viscosity of 3,500 mPa·s. Further, the copolymer (A-1) had a weight average molecular weight of 800,000 g/mol. The solid content, viscosity, and weight average molecular weight of the solution of the copolymer (A-1) were measured, and results are shown in Table 2 of FIG. 1.

### Preparation Examples 2 to 19

Solutions of polymers (A-2) to (A-19) were prepared by the same process as in Preparation example 1 except that the monomers were mixed according to the compositions listed in Table 2. Then, the solid content, viscosity, and weight average molecular weight of the solutions of the polymers (A-2) to (A-19) were measured, and results are shown in Table 2. In Table 2, “BA,” “2EHA,” “HEA,” “4HBA,” “HEAA,” “AM,” and “AA” refer to butyl acrylate, 2-ethylhexyl acrylate, 2-hydroxyethyl acrylate, 4-hydroxybutyl acrylate, hydroxyethyl acrylamide, acrylamide, and acrylic acid, respectively.

### Example 1

286 parts by weight of the solution of the copolymer (A-1) (100 parts by weight of the solid copolymer) obtained in Preparation example 1, 0.5 parts by weight of CARBODILITE V-01 (B-1 in Table 1, registered trade name, Nisshinbo Chemical Inc.) as a carbodiimide cross-linking agent (B), and 0.5 parts by weight of Colonate HX (C-1 in Table 1, registered trade name, Nippon Polyurethane Industry Co., Ltd.) as an isocyanate cross-linking agent (C) were thoroughly mixed at room temperature (25° C.) for 10 minutes, thereby producing an adhesive composition solution.

The adhesive composition solution was applied to a PET release film (MRF38, Thickness: 38 μm, Mitsubishi Polyester Film Inc.) to a dry thickness of 25 μm and dried at 90° C. for 3 minutes, thereby forming an adhesive layer. Then, a PET film (Lumirror S10, #25 (registered trade name), Thickness: 23 μm, Toray Industries) was attached to the adhesive layer, thereby producing a surface protection film (1).

### Examples 2 to 10 and Comparative Examples 1 to 9

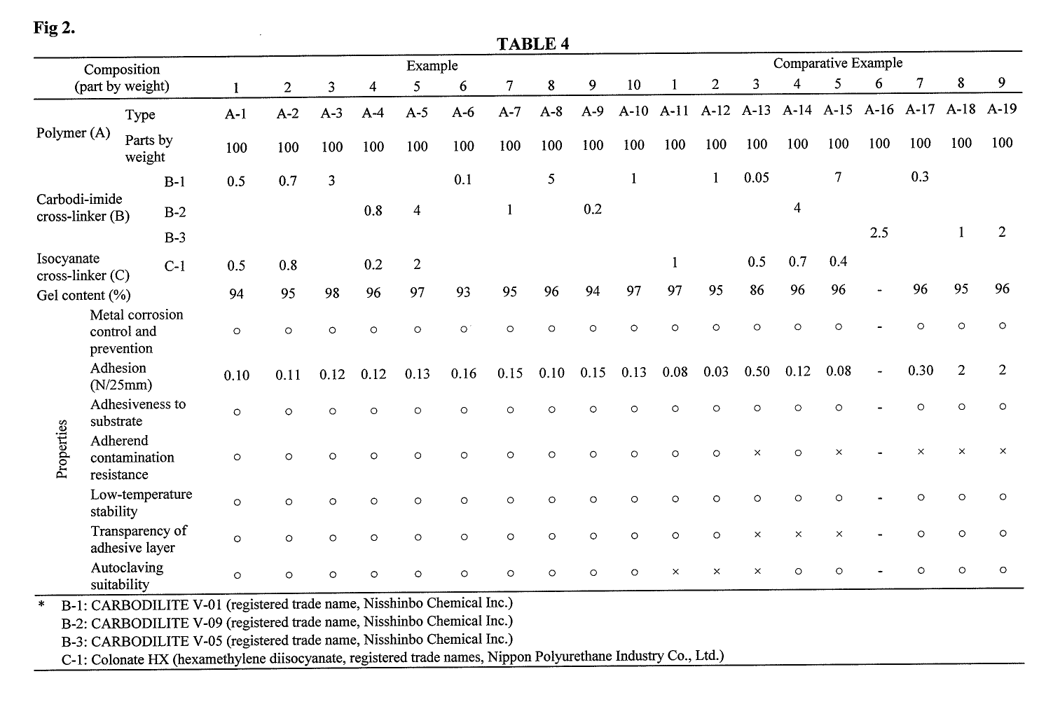

The same process as in Example 1 was performed except that the polymers obtained in Preparation examples 2 to 19, the carbodiimide cross-linking agent, and the isocyanate cross-linking agent were used according to the compositions listed in Table 4 of FIG. 2, thereby preparing the solutions of adhesive compositions (adhesive composition solutions) and then producing surface protection films (2) to (10) according to Examples 2 to 10 and surface protection films (1) to (9) according to Comparative Examples 1 to 9. Details of the carbodiimide cross-linking agents B-2 and B3 are illustrated in Table 3.

TABLE 3
Carbodiimide cross-linking agents (B)

| | |
|---|---|
| B-2 | CARBODILITE V-05 (registered trade name, Nisshinbo |
| | Chemical Inc) |
| B-3 | CARBODILITE V-09 (registered trade name, Nisshinbo |
| | Chemical Inc) |

The properties of the surface protection films (1) to (10) according to Examples 1 to 10 and the surface protection films (1) to (9) according to Comparative Examples 1 to 9 were evaluated as follows, and results are shown in Table 4 of FIG. 2.

1. Metal Corrosion Control and Prevention

The adhesive layer side of each surface protection film, left at 23° C. and 50% RH (relative humidity) for 7 days, was attached to aluminum foil and left at 60° C. and 90% RH for 2 days, followed by observation of corrosion. In Table 4, no change is represented by “0,” while whitening is represented by “X.”

2. Autoclaving Suitability

Each surface protection film, left at 23° C. and 50% RH for 7 days, was cut into 25 mm wide pieces. The pieces were attached to a polarizer plate and autoclaved at 50° C. and 0.49 MPa (5 kg/cm²) for 20 minutes, followed by observation of bubbles. In Table 4, no occurrence of bubbles is represented by “0,” while occurrence of bubbles is represented by “X”.

3. Adhesion

Each surface protection film, left at 23° C. and 50% RH for 7 days, was cut into 25 mm wide pieces. The pieces were attached to a polarizer plate and autoclaved at 50° C. and 0.49 MPa (5 kg/cm²) for 20 minutes. The adhesion (N/25 mm) of the adhesive layer was measured according to a testing method of pressure-sensitive adhesive tapes and sheets disclosed in JIS Z0237, 2000, using a tensile tester at a stripping angle of 180° and a stripping rate of 0.3 m/min under 23° C./50% RH conditions.

4. Adhesiveness to Substrate

While measuring the adhesion, the adhesiveness to the protection film (substrate) was evaluated. In Table 4, the adhesive layer not released from the protection film is represented by “0,” while the adhesive layer released from the protection film is represented by “X.”

5. Adherend contamination resistance

The contact angle of each polarizer plate was measured before and after measurement of adhesion. The contact angle was measured according to a testing method of wettability of glass substrates disclosed in JIS R3257, 1999. In Table 4, a change in the contact angle of the polarizer plate of 3° or less before and after measurement of the adhesion is represented by “O,” while a change in the contact angle of the polarizer plate before and after measurement of the adhesion is represented by “X.”

6. Low-Temperature Stability

Each surface protection film, left at 23° C. and 50% RH for 7 days, was attached to a polarizer plate and autoclaved at 50° C. and 0.49 MPa (5 kg/cm²) for 20 minutes. Then, the product was left at −40° C. for 120 hours, followed by observation of appearance. In Table 4, no occurrence of bubbles, damage, release, or extracted materials is represented by “0,” while occurrence of bubbles, damage, release, or extracted materials is represented by “X.”

7. Transparency of Adhesive Layer

Each surface protection film, left at 23° C. and 50% RH for 7 days, was observed with the naked eye to evaluate the transparency of the adhesive layer. In Table 4, proper transparency is represented by “0,” while occurrence of whitening of the adhesive layer is represented by “X.”

8. Gel Content

In Examples 1 to 10 and Comparative examples 1 to 9, the adhesive layer was formed on a polyester film instead of the PET film, followed by measurement of gel content (%) after 7 days. In measurement of the gel content, about 0.1 g of the adhesive composition, left at 23° C. and 50% RH for 7 days, was taken and defined as W1(g). This composition was put in a sample bottle, and about 30 g of ethyl acetate was added thereto and left for 24 hours. After a predetermined time, the contents of the bottle were filtered through a 200-mesh stainless steel mesh (weight: W2(g)). The mesh and the remaining materials were dried at 90° C. for 1 hour, and the total weight W3(g) was measured. The gel content (%) was calculated using the measured values and Equation 2.

Gel content(%)={(W3−W2)/W1}×100 [Equation 2]

Results of each evaluation are shown in Table 4 of FIG. 2. In Table 4, properties of the surface protection film 6 according to Comparative Example 6 were not evaluated since the composition was gelated after adding the cross-linking agent so that a sheet was not obtained.

As shown in Table 4, the surface protection films (1) to (10) according to Examples 1 to 10 have excellent adherend contamination resistance, transparency of the adhesive layers, and autoclaving suitability as compared with the surface protection films (1) to (9) according to Comparative Examples 1 to 9.

As described above, embodiments relate to an adhesive composition to form an adhesive layer having excellent adherend contamination resistance and transparency, and a surface protection film having excellent adherend contamination resistance and transparency.

By way of summation and review, if a flat display panel is inspected after a surface protection film is attached, the presence of bubbles in an adhesive layer on the surface protection film may affect a determination of whether the flat display panel satisfies an acceptable level to pass inspection. For this reason, an adhesive composition may be applied to a protection film after defoaming, but bubbles may be present in an adhesive layer even after defoaming treatment.

According to an embodiment, a surface protection film for an optical member of a flat display panel may be provided with an adhesive layer that is transparent, does not include or form bubbles, e.g., in autoclaving, and has excellent adherend contamination resistance so as not to contaminate the adherend after removal of the surface protection film therefrom. In addition, the surface protection film may be easily released from the flat display panel after long-term storage, e.g., where the surface protection film is disposed on the flat display panel for a period after inspection. The adhesive composition may control adherend contamination, i.e., may have excellent adherend contamination resistance, and enable an adhesive layer to have excellent transparency. The adhesive composition may have excellent metal corrosion resistance and prevention properties, low-temperature stability, and autoclaving suitability.

According to an embodiment, an adhesive layer may be formed of an adhesive composition using a (meth)acrylate copolymer. In the (meth)acrylate copolymer, a carboxyl group containing monomer may be present in a particular amount or less, The (meth)acrylate copolymer may controls adherend contamination, i.e., have excellent adherend contamination resistance, and may have excellent transparency. The adhesive composition may be effective in bonding adherends of various plastic films, and may be particularly suited for an adhesive layer of a surface protection film of a flat display panel, such as an LCD or PDP.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An adhesive composition, comprising:
100 parts by weight of a (meth)acrylate copolymer including 0 to less than 0.5 parts by weight of a carboxyl group containing monomer, 0.6 to 9 parts by weight of a hydroxyl group containing (meth)acrylic monomer, and 90.5 to 99.4 parts by weight of a (meth)acrylic acid ester monomer, and having a weight average molecular weight of 100,000 g/mol to less than 1,000,000 g/mol; and
0.1 to 5 parts by weight of a carbodiimide cross-linking agent.

2. The adhesive composition as claimed in claim 1, wherein said (meth)acrylate copolymer has a weight average molecular weight of 200,000 g/mol to 900,000 g/mol.

3. The adhesive composition as claimed in claim 1, further comprising 0.05 to 3 parts by weight of an isocyanate cross-linking agent.

4. The adhesive composition as claimed in claim 1, wherein said (meth)acrylate copolymer further comprises at least one of an epoxy group containing acrylic monomer, an amino group containing acrylic monomer, a phosphate group containing acrylic monomer, a sulfonic acid group containing acrylic monomer, a urethane group containing acrylic monomer, a phenyl group containing acrylic vinyl monomer, a silane group containing vinyl monomer, styrene, chlorostyrene, α-methylstyrene, vinyltoluene, vinyl chloride, vinyl acetate, vinyl propionate, acrylonitrile, and vinyl pyridine.

5. The adhesive composition as claimed in claim 1, further comprising a silane coupling agent.

6. The adhesive composition as claimed in claim 1, wherein said adhesive composition has a viscosity of 500 to 6,000 mPa·s at 25° C.

7. A surface protection film including a protection film and an adhesive layer formed on at least one side of the protection film, wherein said adhesive layer comprises the adhesive composition as claimed in claim 1.

8. The surface protection film as claimed in claim 7, wherein said adhesive layer has an adhesion of 0.02 to 0.2 N/25 mm based on JIS Z0237.
